(19) United States
(12) Patent Application Publication
(10) Pub. No.: US 2022/0270108 A1
(43) Pub. Date: Aug. 25, 2022

(54) PRODUCT RETURNS BASED ON INTERNAL COMPOSITION RULES

(71) Applicant: INTERNATIONAL BUSINESS MACHINES CORPORATION, ARMONK, NY (US)

(72) Inventors: Igor S. Ramos, Round Rock, TX (US); Anindita Das, Austin, TX (US); Ohannes Ohannessian, Round Rock, TX (US)

(21) Appl. No.: 17/184,700

(22) Filed: Feb. 25, 2021

(51) Int. Cl. G06Q 30/00; G06N 20/00; G06Q 30/06; G06T 7/00

(52) U.S. Cl. CPC G06Q 30/012; G06N 20/00; G06Q 30/0627; G06T 7/0006; G06T 2207/10116

(57) ABSTRACT

A method, computer system, and a computer program product for internal product composition analysis is provided. The internal product composition analysis may begin by receiving a product return identifier associated with a product and then retrieving a plurality of product data based on the received product return identifier, wherein the retrieved plurality of product data includes one or more expected features. Then one or more internal images of the product are generated and one or more internal features of the product are identified from the generated one or more internal images The identified one or more internal features may then be compared with the one or more expected features and in response to determining that the identified one or more internal features match the one or more expected features, accepting the product return.

### BACKGROUND

The present invention relates generally to the field of computing, and more particularly to image analysis.

A core aspect of e-commerce centers around the handling of physical goods. Products are packed and shipped between warehouses and customers. This process introduces chances for mistakes, such as the wrong product being shipped, which can cost businesses and consumers alike in time and money. One area of concern for businesses is fraudulent returns and its associated costs. Properly screening returns can cost additional time and money.

### SUMMARY

According to one exemplary embodiment, a method for internal product composition analysis is provided. The method may include receiving a product return identifier associated with a product and then retrieving a plurality of product data based on the received product return identifier, wherein the retrieved plurality of product data includes one or more expected features. The method may then generate one or more internal images of the product and identify one or more internal features of the product from the generated one or more internal images The identified one or more internal features may then be compared with the one or more expected features and in response to determining that the identified one or more internal features match the one or more expected features, accepting the product return. A computer system and computer program product corresponding to the above method are also disclosed herein.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for internal composition rules-based returns according to at least one embodiment;

FIG. 3 is a block diagram of the illustrating a typical return process flow;

FIG. 4 is a block diagram of the illustrating an internal composition rules-based return flow according to at least one embodiment;

FIG. 5 depicts an exemplary internal product feature composition analysis according to at least one embodiment;

FIG. 6 is a block diagram of internal and external components of computers and servers depicted in FIG. 1 according to at least one embodiment;

FIG. 7 is a block diagram of an illustrative cloud computing environment including the computer system depicted in FIG. 1, in accordance with an embodiment of the present disclosure; and

FIG. 8 is a block diagram of functional layers of the illustrative cloud computing environment of FIG. 7, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

As described previously, a core aspect of e-commerce centers around the handling of physical goods. Products are packed and shipped between warehouses and customers. This process introduces chances for mistakes, such as the wrong product being shipped, which can cost businesses and consumers alike time and money. One area of concern for businesses is fraudulent returns and its associated costs. Properly screening returns can cost additional time and money. Often a business may not identify a fraudulent return until the expense of shipping a package to a triage center has already occurred. Thus, the fraudulent or otherwise unacceptable return has, in many cases, been shipped from a collection point to a distribution center, then through airports, and so forth. For many businesses, ensuring returns are legitimate is too time consuming and complicated for practical, systematic checks of each and every return before processing the refund to the consumer. Business goodwill may also be harmed if consumers routinely have to wait five minutes or more while their return is scrutinized as this may signal to some consumers a lack of trust by a business.

Therefore, it would be advantageous to, among other things, provide a way to accurately and quickly ascertain valid product returns at the start of the product return flow, thereby saving time and resources while maintaining business goodwill.

The following described exemplary embodiments provide a system, method and program product for screening product returns based on internal composition rules. As such, the present embodiment has the capacity to improve the technical field of image analysis by obtaining x-ray or other internal images of product returns and analyzing the resulting images in comparison to the expected internal composition of the return to quickly detect anomalies. More specifically, the customer's return box may be scanned to identify the product being returned. Once the product being returned is determined, the specific internal components expected may be retrieved. Additionally, the applicable terms of the acceptance policy may be retrieved. Thereafter, internal images may be obtained of the customer's return and compared with the expected internal components. Each internal component or feature may be analyzed to determine if the component is present and otherwise in acceptable condition per the acceptance policy. If all such internal components are acceptable, the product return as a whole may be accepted. However, if the internal analysis of the product return fails to meet the acceptance policy (e.g., due to missing or incorrect internal components), then the product return may be rejected.

According to at least one embodiment, imaging technology may be used to generate a representation of the internal composition of the contents of shipping boxes (or product boxes). These generated images may then be analyzed in real-time at the time the product is dropped off for return by the customer, at a distribution center, or triage center (i.e., a location where product returns may be opened, inspected, and evaluated by personnel) and re-route the shipping boxes according to the outcome of the analysis and the rules set for that business process.

Embodiments use an internal imaging device (e.g., three dimensional (3D) x-ray scanner) embedded, for example, in the return counter in a store, a return locker, or other designated return point. As the customer returns an item, the disclosed system identifies the item and compares the item with accepted return criteria for that product. If the item is deemed unacceptable, the customer may address the mistake before the package is accepted. In such scenarios, there may be no need to ship the item to a triage center, thus avoiding unnecessary shipping and handling costs.

The disclosed embodiments allow for processing internal composition images in one or more view angles that may be compared to a known product model. For example, determining that a returned laptop looks like a laptop. By retrieving data for a product associated with the customer's order and subsequent return, the comparison of the internal composition images against known images may provide automatic anomaly detection. To increase the accuracy of the anomaly detection, and more intelligently handle returns, further details may be evaluated based on the internal composition images. For instance, internal composition imaging may detect damage to the product being returned (e.g., scratches, dents, cracks). In some embodiments, internal composition imaging may be used to read serial numbers that may be compared to data listing the serial numbers of the parts in the specific product the customer is returning. Additionally, internal composition imaging may be used to identify that constituent components (e.g., a processor or hard drive in a laptop) are present and also are the expected components within the product return. In other embodiments, internal indicators may be present within the product, such as a moisture indicator (i.e., indicating the product was exposed to more than acceptable amount of moisture), that may be detected via the internal composition images. In some embodiments, a rules system may be used that compares the actual product return characteristics to the expected characteristics and accept the return, reject the return, or issue a partial refund (e.g., a missing item may allow the return to be accepted with a fixed reduction in the money returned to the consumer) accordingly.

The embodiments disclosed herein may be advantageous by efficiently detecting fraudulent or unacceptable product returns and reducing refund processing time. Furthermore, businesses may save money by detecting fraudulent returns early at the collection point instead of the end of the product return flow (e.g., at a triage center). A customer's wait time may be reduced when returning products and immediate refunds issued that may increase customer satisfaction and goodwill with the business.

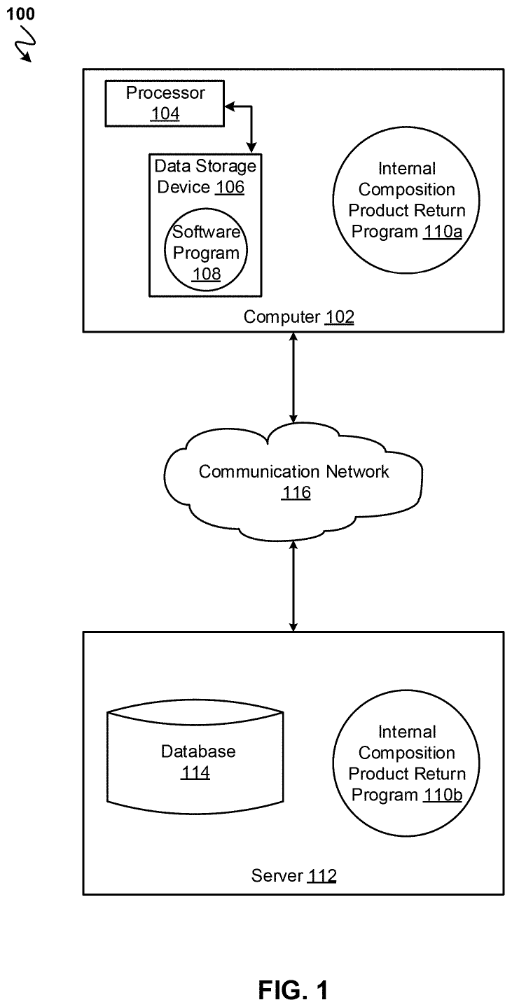

Referring to FIG. 1, an exemplary networked computer environment 100 in accordance with one embodiment is depicted. The networked computer environment 100 may include a computer 102 with a processor 104 and a data storage device 106 that is enabled to run a software program 108 and an internal composition product return program 110a. The networked computer environment 100 may also include a server 112 that is enabled to run an internal composition product return program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

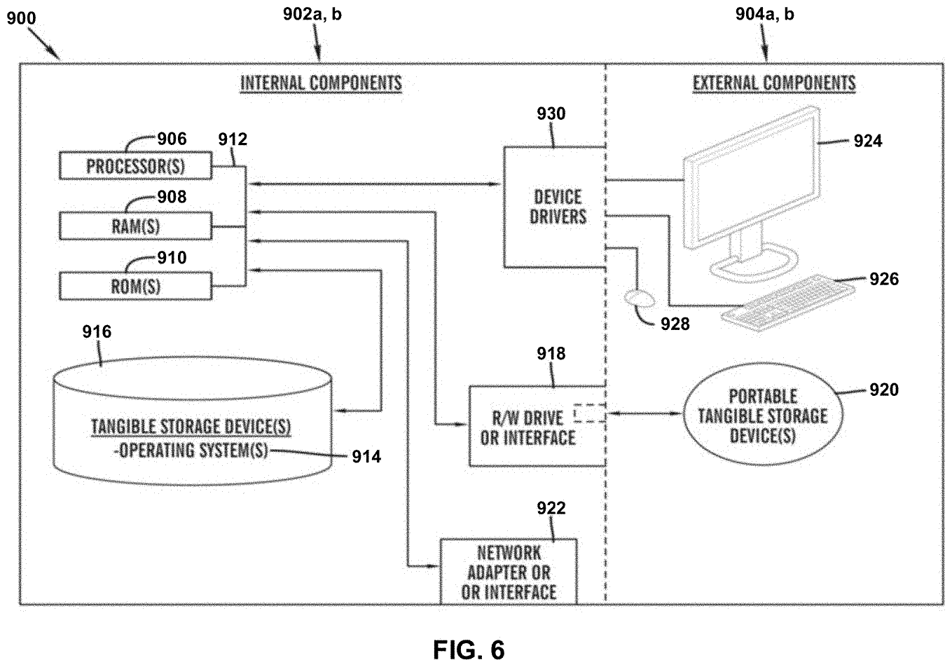

The client computer 102 may communicate with the server computer 112 via the communications network 116. The communications network 116 may include connections, such as wire, wireless communication links, or fiber optic cables. As will be discussed with reference to FIG. 6, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the internal composition product return program 110a, 110b may interact with a database 114 that may be embedded in various storage devices, such as, but not limited to a computer/mobile device 102, a networked server 112, or a cloud storage service.

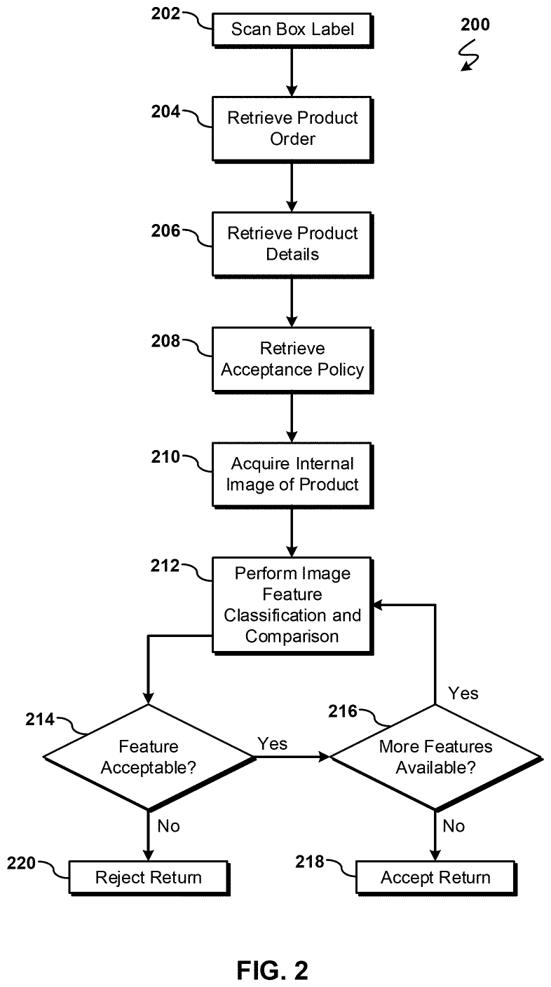

According to the present embodiment, a user using a client computer 102 or a server computer 112 may use the internal composition product return program 110a, 110b (respectively) to obtain internal composition images of product returns at the drop-off or collection point and analyze the internal composition of a product return to determine if the return will be accepted or rejected. The internal composition product return method is explained in more detail below with respect to FIGS. 2-5.

Referring now to FIG. 2, an operational flowchart illustrating the exemplary internal composition rules-based returns process 200 used by the internal composition product return program 110a and 110b according to at least one embodiment is depicted.

At 202 a label on a box containing the product return is scanned. According to at least one embodiment, the label on the product return may be scanned using an optical scanner at a product return collection point (e.g., a store or package locker). In embodiments, the optical scanner may read the label by identifying a barcode, Quick Response (QR) code, or use optical character recognition (OCR) to read letters and words printed on the label to identify the product being returned. In some embodiments, the customer's purchase receipt or other paperwork may be scanned. For example, customer Joe Doe may return a laptop purchased from Company B by bringing the laptop to a package delivery store. Joe Doe packed the laptop for return within a box having a label with a barcode that Company B provided to Joe Doe. When the Joe Doe brings the boxed laptop to the Acme Electronics retail store, a customer service employee may scan the barcode on the box label with an optical scanner built in to a counter in the store. The barcode may be decoded and used to look up within an order database (e.g., database 114) the order number associated with the bar code. For example, order number 1970396 may be returned from the order database.

Next, at 204, the product order corresponding with the returned product is retrieved. According to at least one embodiment, identifying information obtained from the scan at 202 may be used to retrieve product order data for the product being returned. Product order data may include numerous pieces of data related to the original transaction between the customer and business. For example, the product order data may include order details (e.g., order number, purchase date), product details (e.g., product serial number, date of manufacture), customer information (e.g., payment method, shipping address), and return eligibility (e.g., whether the item being returned meets the return window criteria). The product order data may be stored in a storage repository, such as a database 114. The specific product order data being requested may be queried, for example, using the order number obtained from the box label scan at 202.

Continuing the previous example, order number 1970396 may be queried from the product order data database and return the product order data corresponding with order number 1970396. The retrieved product order data includes the customer's name (Joe Doe), the customer's shipping address (123 Main Street), the product sold (Laptop X Pro), and the product serial number (XYZ486).

Then, at 206, the details of the returned product are retrieved. In embodiments, the product order data may be used to retrieve details regarding the internal composition of the product being returned. In some embodiments, the serial number retrieved previously may be used to query a storage repository, such as a database 114, containing details of the internal composition of the product assigned to the retrieved serial number (e.g., XYZ486). The product detail data may include the product make (e.g., Laptop X), model (e.g., Pro), manufacturer (e.g., Company B), product specifications (e.g., 1 terabyte solid state drive, 16 gigabytes of random access memory (RAM), 3.2 gigahertz quadcore processor), and package contents (e.g., alternating current (AC) adapter, stylus, headphones). Additionally, internal images of the original product or equivalent product may be retrieved. For example, if the collection point is known to have a 3D x-ray imaging device (e.g., based on looking up location data corresponding with the collection point stored in a database 114), previously generated 3D x-ray images of the internal composition of a Laptop X Pro having the same configuration (i.e., same hard drive, RAM, etc.) may also be retrieved.

At 208, the acceptance policy for the product is retrieved. According to at least one embodiment, the product order data may be used to retrieve the acceptance policy the customer agreed to when making the original purchase. The acceptance policy may be stored in a data repository, such as a database 114. In embodiments, the acceptance policy may be retrieved based on the order number. The acceptance policy contains terms, or rules, that the customer agreed to when purchasing the product. The terms may indicate, for example, that no returns will be accepted which have been exposed to moisture exceeding a threshold (e.g., triggering a moisture indicator inside a device), or that missing or altered internal components may result in rejecting the return. Other acceptance policy terms may indicate that accessories (e.g., AC adapter) not being returned may result in a partial refund. For example, if the AC adapter is missing, $40 may be deducted from the customer's refund. Other terms may indicate the impact that damage (e.g., scratches, dents) may have on the return (e.g., reject the return or deduct from the refund amount).

Continuing the previous example, Joe Doe's order number 1970396 may have an acceptance policy that Joe Doe agreed to when purchasing his Laptop X Pro that specifies that water damage, dents, or mismatched internal components will result in rejecting the return. The acceptance policy also indicates that missing accessories that were originally included with Laptop X Pro will result in appropriate deductions from the amount of money refunded to Joe Doe.

Next, at 210, one or more images of the internal features of the returned product is acquired. A variety of internal imaging devices and technologies may be used to acquire images of the internal features of the product a customer is returning without opening the box or packaging, depending on the implementation. According to some embodiments, x-rays (e.g., 3D x-ray scanning), computer tomography (CT) scanners, and the like may be used to acquire images of internal features and obtain images from a variety of angles in order to properly analyze the internal composition of the product return. In embodiments, these imaging devices may be present at the product return collection point (e.g., customer service counter in a retail store, drop box, package pick up locker). As such, the images of internal features or components may be acquired in real-time as the customer brings in the product to return. For example, a counter in a customer service department may contain a 3D x-ray imaging device to scan packages where the customer drops off a return. Continuing the prior example, Joe Doe may bring his boxed Laptop X Pro for return to the customer service counter in the retail store Acme Electronics. The customer service counter may have a built-in 3D x-ray imaging device which will produce images of the internal components of Joe Doe's return from a variety of angles.

It may be appreciated that in some embodiments, the internal imaging device may be present at another location early in the return flow (e.g., a distribution center that receives the return from the collection point). This may be more advantageous in scenarios when the collection point cannot practically support the imaging device (e.g., a small business that cannot afford the cost for such equipment or lack sufficient space for the device). However, imaging the product return and intelligently deciding to reject or accept a return may still be done early in the return flow to realize advantages in cost savings for businesses.

Then, at 212, image features are classified and compared to expected feature images in real-time. In embodiments, the internal images of the returned product acquired at 210 may be compared with images taken of the original product to identify the presence of the expected features (e.g., hard drive). Image classification and similarity algorithms may be implemented, for example, using supervised deep learning algorithms. For instance, image classification algorithms that may be used include K-Nearest Neighbor (KNN), Support Vector Machine (SVM), Ensemble Learning, Multi-layer Perceptron (MLP), and Convolutional Neural Networks (CNNs). In embodiments, the internal composition images of the customer's product return may be input into an image classification algorithm to identify individual internal features or components.

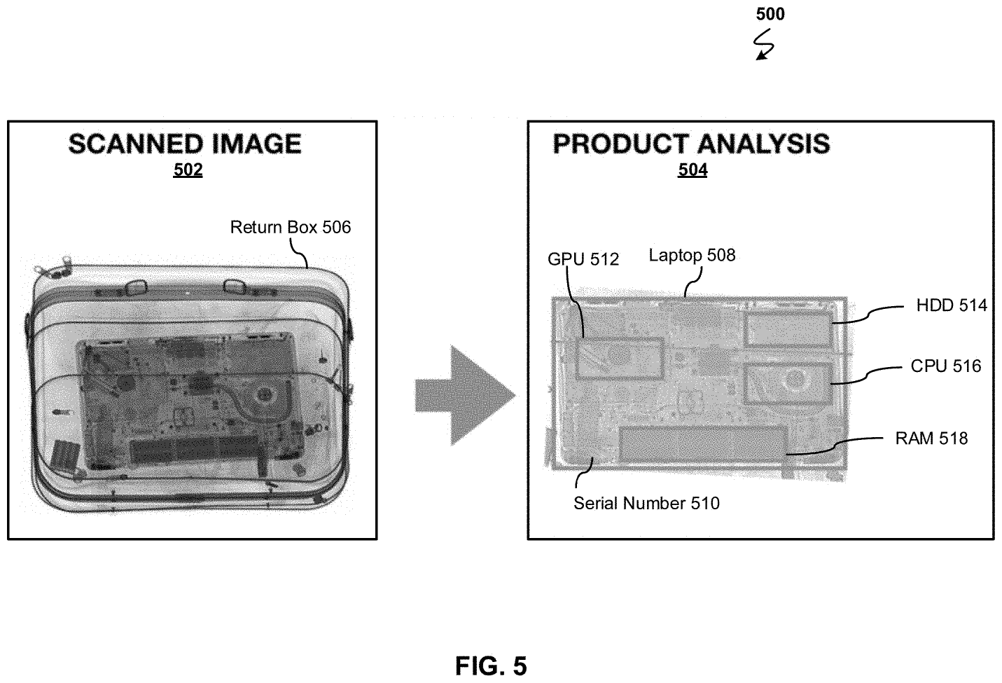

The internal features may be identified using, for example, by supervised machine learning models trained on 3D x-ray images of the product and relevant constituent product features. For example, a 3D x-ray image of Laptop X Pro may be used to train the supervised machine learning model. Additionally, 3D x-ray images of the constituent components (e.g., hard drive, graphics processing unit (GPU)) may also be used to train the supervised machine learning model. Once the supervised machine learning model has been trained on the images of known Laptop X Pros and their constituent components, the supervised machine learning model may be able to identify if, for example, the 3D x-ray image of Joe Doe's product return matches a Laptop X Pro and classify the constituent components within the laptop. In some embodiments, portions of the internal images may be copied to create images of each individual feature or component. For example, the 3D x-ray of Joe Doe's Laptop X Pro may result in a subset of images representing the constituent components (i.e., an image of the hard drive, an image of the GPU, and so on). In other embodiments, the boundaries of regions within the internal composition image corresponding with each component may be recorded. Thereafter, the images or defined image regions depicting individual components may be input into a classification algorithm, such as a CNN, to determine, for example, that component CA is classified as a hard drive and component CB is classified as RAM. An example of this process is shown in greater detail with respect to FIG. 5.

The retrieved product data at 206 may include baseline images of the internal composition of a product equivalent to the customer's returned product, thus constituting images of the expected features. The baseline images and the acquired returned product images may be compared using image classification or image similarity algorithms. Continuing the prior example, the image of hard drive component CA may be compared with the earlier retrieved image of a hard drive matching the 1 terabyte solid state drive from manufacturer W that Joe Doe's Laptop X Pro was shipped with using a CNN algorithm. If Joe Doe had replaced the original solid state drive in his Laptop X Pro with a 128 gigabyte drive from manufacturer H, the resulting image similarity analysis may generate a similarity score (e.g., on a normalized scale between 0 and 1, with 0 being most similar) of 0.6.

At 214 a determination is made if the feature being analyzed is acceptable. In embodiments, an image similarity score or the like may be compared to a predefined threshold value to determine if the feature is acceptable. Continuing the prior example of Joe Doe's hard drive with a similarity score of 0.6, if the threshold similarity value is 0.2, the hard drive in Joe Doe's return exceeds the threshold and will be deemed unacceptable, provided the acceptance policy requires the hard drive to match the original. If, however, Joe Doe had not replaced the hard drive in his Laptop X Pro, the resulting similarity score for the hard drive may be 0.1, and being below the 0.2 threshold, the feature would be deemed acceptable.

In some embodiments, if the feature comparison step cannot be completed with sufficient confidence, a triage specialist may be alerted remotely via a message sent over a communication network 116 to a computer 102 that the triage specialist is using. In the case of making a comparison decision, after notifying the triage specialist, the acquired internal component image of the feature or component in question may be sent with the image of the expected component. The images may then be displayed to the triage specialist within a user interface along with a button or other user interface feature allowing the triage specialist to indicate that the feature is acceptable or not. The user interface may also allow the triage specialist to perform some image manipulations (e.g., zoom, contrast) in order to aid them in their decision. Once the triage specialist's decision is indicated, the decision may then be transmitted back via the communication network 116. It may be appreciated that in some embodiments, a triage specialist may be tasked to provide similar input if the component classification at 212 cannot be completed with sufficient confidence, in which case the triage specialist may be provided the image of a feature together with baseline images of the expected features and provided with a user interface that allows the triage specialist to assign a classification (e.g., RAM) to the feature in question.

In some embodiments, additional analysis of the feature image may be performed to determine if the feature is damaged. Further image analysis algorithms, using a pre-trained CNN for example, may be used to detect cracks, dents, or other damage. Thus, features that meet the similarity threshold may still be rejected if a threshold amount of damage is detected.

As noted above, the acceptance policy retrieved at 208 may be used to determine if a feature is acceptable. If the acceptance policy requires all features to be present and match, then any mismatched or missing component will lead to rejecting the return. Another feature that may be analyzed is a moisture indicator. If the moisture indicator indicates moisture exposure, then the return may be rejected, per the acceptance policy.

If the feature analyzed and evaluated at 214 is acceptable, then it is determined if there are more features to analyze at 216. In some embodiments, based on the product data retrieved previously at 206, the expected features for analysis may be known. As features are determined to be acceptable at 214, a running list of accepted features may be built and compared with the list of expected features. If there are expected features that have not yet been found on the accepted features list, then the internal composition rules-based returns process 200 returns to 212 to classify and compare a new feature. In other embodiments, the internal composition rules-based returns process 200 will return to 212 as long as additional features identified at 210 remain unanalyzed and unevaluated. If all features have been analyzed, then the return is accepted at 218.

However, if a feature was not found acceptable at 214, then the return is rejected at 220. Since the internal composition rules-based returns process 200 may be performed in real-time, the customer may be notified at the collection point that their product return has been rejected. For example, if Joe Doe's Laptop X Pro had the hard drive replaced, the return would not be accepted and Joe Doe would be notified at the collection point instead of shipping the product return to a point where a triage specialist would be able to evaluate the return. As such, the time to make return acceptance decisions and the costs of transporting a return that would ultimately be unacceptable are reduced.

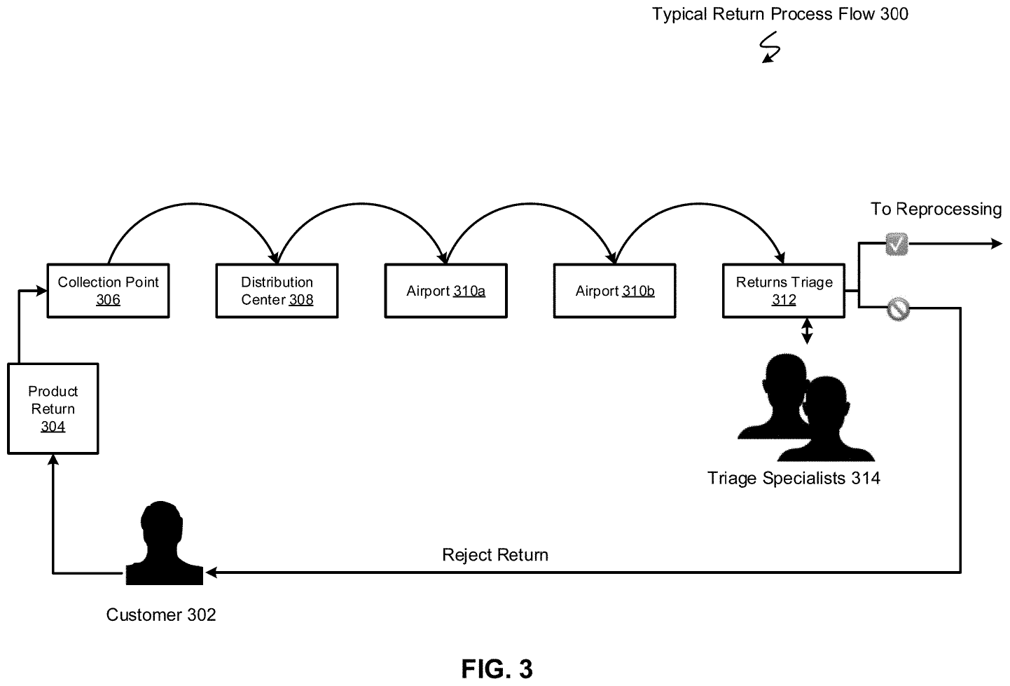

Referring now to FIG. 3, a block diagram illustrating a typical return process flow 300 is depicted. The return process flow 300 begins with a customer 302 bringing a product return 304 to a collection point 306. Applying the example scenario above to the typical return process flow 300 depicted in FIG. 3, customer 302 Joe Doe may return his Laptop X Pro (product return 304) to the retail store customer service department at Acme Electronics that is the collection point 306. Thereafter, the product return 304 is transported from the collection point 306 to a distribution center 308 before moving to an airport 310a. The product return 304 is then transported via airplane to destination airport 310b. Finally, the product return 304 is shipped to a returns triage 312 where triage specialists 314 inspect the product return 304. Continuing the above example, if the triage specialists 314 discover that customer 302 Joe Doe replaced the hard drive, the product return 304 will be rejected and then need to be sent back to Joe Doe. Thus, transporting the product return 304 from the collection point 306 all of the way to the returns triage 312 results in lost money for shipping and handling expenses, increased pollution from shipping the product return 304 only to have to ultimately send the product return 304 back to the customer 302, and lost time.

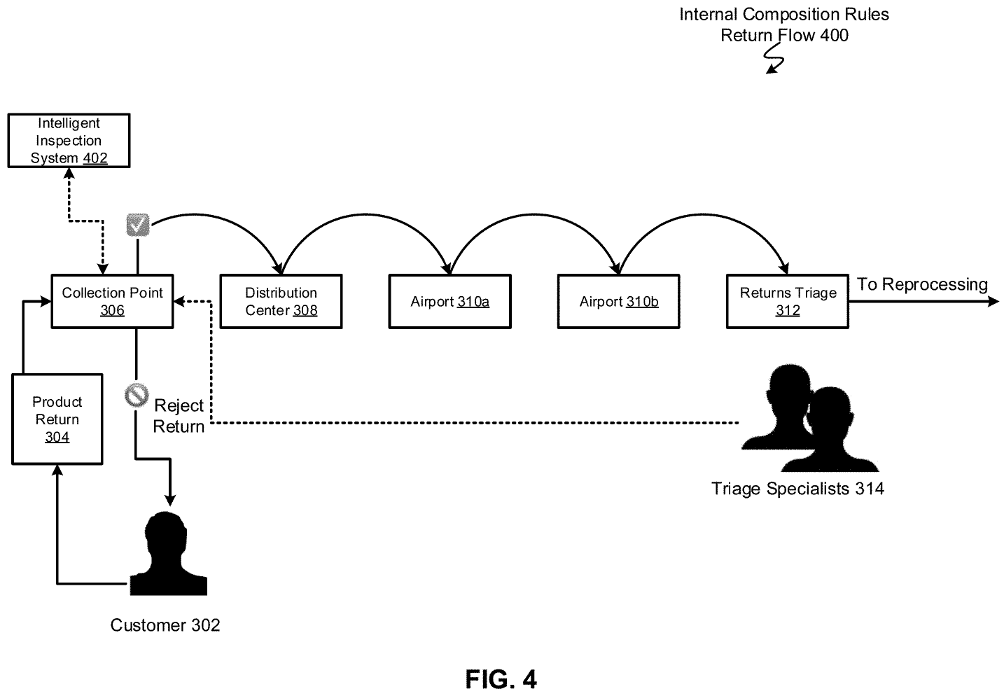

Referring now to FIG. 4, a block diagram illustrating an internal composition rules return flow 400 is depicted according to at least one embodiment. In contrast to the typical return process flow 300 depicted previously in FIG. 3, the internal composition rules return flow 400 uses an intelligent inspection system 402 utilizing the internal composition rules-based returns process 200 described previously in FIG. 2. This time, customer 302 Joe Doe brings his Laptop X Pro as a product return 304 to the retail collection point 306 at Acme Electronics that has a 3D x-ray imaging device as part of the intelligent inspection system 402. Once Joe Doe hands the product return 304 to customer service personnel, the box label on the product return 304 is scanned by customer service personnel, as described previously with respect to step 202. Thereafter, the rest of the steps in the internal composition rules-based returns process 200 continue. In other words, the product order is retrieved 204, the product details are retrieved 206, the acceptance policy is retrieved 208, the imaging device acquires internal images of the product 210, image feature classification and comparison are performed 212, feature acceptability is determined 214, and so on as described above with respect to FIG. 2 until the return is accepted 218 or rejected 220. If Joe Doe changed the hard drive in his Laptop Pro X, then in accordance with the acceptance policy, his product return 304 will be rejected in real-time while Joe Doe is at the collection point 306. The customer service personnel can immediately inform Joe Doe and give the product return 304 back to Joe Doe. Thus, in contrast to the typical return process flow 300 depicted previously in FIG. 3, the internal composition rules return flow 400 has saved the expense of shipping the product return 304 to the distribution center 308, airports 310a and 310b, returns triage 312, and shipping the product return 304 back to the customer 302. Instead, customer 302 Joe Doe is quickly notified that the product return 304 cannot be accepted while Joe Doe is still at the collection point 306. In alternative embodiments, if the intelligent inspection system 402 is unable to determine if features of the product return 304 are acceptable, then as discussed previously, the triage specialists 314 may be contacted remotely to decide. Alternatively, if Joe Doe has not changed the hard drive and the product return 304 is ultimately acceptable, the business will now only incur the costs of shipping the product return 304 all the way to the returns triage 312 and on to reprocessing knowing that the product return 304 is worth the expense to ship for reprocessing.

Referring now to FIG. 5, an internal product feature composition analysis 500 using an internal scanned image 502 and subsequent product analysis 504 is depicted according to at least one embodiment. The internal scanned image 502 depicts the product return box 506 obtained using an internal imaging device, as described previously at step 210 of FIG. 2. Thereafter, the internal scanned image 502 is input into an image classification algorithm as described previously with respect to step 212. The resulting product analysis 504 image identifies and classifies the returned laptop 508 and the laptop's 508 internal features or components. As depicted in the product analysis 504, a serial number 510, a GPU 512, a hard disk drive (HDD) 514, a central processing unit (CPU) 516, and RAM 518 are all identified and classified from the internal images using an image classification algorithm.

It may be appreciated that FIGS. 2, 4, and 5 provide only an illustration of one embodiment and does not imply any limitations with regard to how different embodiments may be implemented. Many modifications to the depicted embodiment(s) may be made based on design and implementation requirements.

For example, in some embodiments, the acceptance policy may indicate that missing accessories may allow for the product to be returned after deducting a predefined amount of money from the refund total. For instance, if Joe Doe does not include the AC adapter in the product return, the internal composition rules-based returns process 200 may determine at 214 that the feature is missing and after parsing the terms of the acceptance policy allow the internal composition rules-based returns process 200 to proceed to 216 to check for more available features while processing a predefined deduction of $40 from the refund total of $1000.

In other embodiments, the internal composition rules-based returns process 200 may generate a list of the expected features, as discussed above, and at 216 may determine any feature not found (i.e., no more available features are left to analyze and one or more expected features were not found in the return) will result in rejecting the return in accordance with the acceptance policy. For example, as discussed above, if the AC adapter feature is missing, the acceptance policy may allow the return with a deduction in the money returned to the customer. In another example, a laptop battery may be missing which will result in the return being rejected.

It may also be appreciated that certain steps described in internal composition rules-based returns process 200 may be occur in a different order or concurrently, depending on implementation. For example, in some embodiments, acceptance policy retrieval 208 may occur before retrieving product details 206. In other embodiments, acceptance policy retrieval 208 and retrieving product details 206 may occur simultaneously.

As described in embodiments above, the internal composition product return program 110a and 110b may improve the functionality of a computer or other technology by providing a method for effective product return decisions by intelligently analyzing internal imaging of products, classifying internal components, and deciding in view of an acceptance policy if a product may be returned in real-time. By combining machine learning algorithms with acceptance policy rules, internal image scans provide a way to unobtrusively determine if product returns are acceptable in real-time. As such business goodwill is increased and time and costs are reduced.

FIG. 6 is a block diagram 900 of internal and external components of computers depicted in FIG. 1 in accordance with an illustrative embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 6. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the internal composition product return program 110a in client computer 102, and the internal composition product return program 110b in network server 112, may be stored on one or more computer-readable tangible storage devices 916 for execution by one or more processors 906 via one or more RAMs 908 (which typically include cache memory). In the embodiment illustrated in FIG. 6, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the internal composition product return program 110a and 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the internal composition product return program 110a in client computer 102 and the internal composition product return program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the internal composition product return program 110a in client computer 102 and the internal composition product return program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

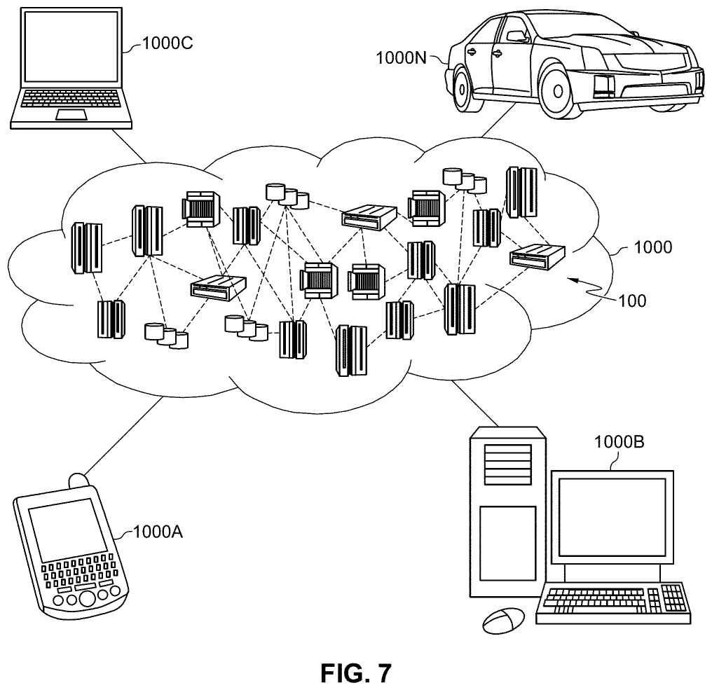

Referring now to FIG. 7, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 7 are intended to be illustrative only and that computing nodes 100 and cloud computing environment 1000 can communicate with any type of computerized device over any type of network and/or network addressable connection (e.g., using a web browser).

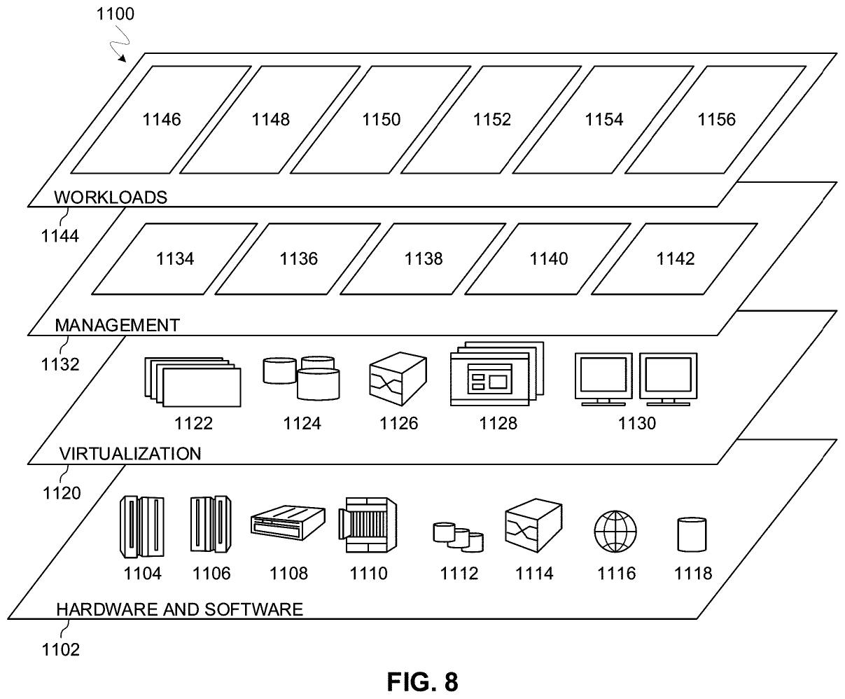

Referring now to FIG. 8, a set of functional abstraction layers 1100 provided by cloud computing environment 1000 is shown. It should be understood in advance that the components, layers, and functions shown in FIG. 8 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and internal composition product returns 1156. An internal composition product return program 110a, 110b provides a way to generate images depicting the internal composition of a product return still inside a box or other packaging and then analyze the images to determine in real-time if the product return should be accepted or be rejected at the time the customer drops off the return.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for internal product composition analysis, the method comprising:
receiving a product return identifier associated with a product;
retrieving a plurality of product data based on the received product return identifier, wherein the retrieved plurality of product data includes one or more expected features;
generating one or more internal images of the product;
identifying one or more internal features of the product from the generated one or more internal images;
comparing the identified one or more internal features with the one or more expected features; and
in response to determining that the identified one or more internal features match the one or more expected features, accepting the product return.

2. The method of claim 1, further comprising:
retrieving an acceptance policy associated with the product based on the product return identifier, wherein the retrieved acceptance policy includes a plurality of acceptance terms;
determining whether the identified one or more internal features satisfies the plurality of acceptance terms; and
wherein accepting the product return further comprises determining that the identified one or more internal features satisfies the plurality of acceptance terms.

3. The method of claim 1, further comprising:
in response to determining that the identified one or more internal features do not match the one or more expected features, rejecting the product return.

4. The method of claim 2, further comprising:
determining that the one or more internal features are damaged; and
wherein the plurality of acceptance terms includes a damage deduction amount associated with a feature, and wherein accepting the product return further comprises deducting the damage deduction amount from a refund total based on determining that the one or more internal features are damaged and a corresponding damage deduction is present in the plurality of acceptance terms.

5. The method of claim 1, wherein the generating of the one or more internal images is performed by an internal imaging device located at a collection point where a customer brings the product for return.

6. The method of claim 1, wherein the one or more expected features comprises receiving one or more expected feature internal images.

7. The method of claim 6, wherein comparing the identified one or more internal features with the one or more expected features comprises using a supervised machine learning algorithm to compare internal feature images corresponding to the identified one or more internal features with the one or more expected feature internal images to determine if the internal feature images match any of the one or more expected feature internal images.

8. A computer system for internal product composition analysis, comprising:
one or more processors, one or more computer-readable memories, one or more computer-readable tangible storage media, and program instructions stored on at least one of the one or more computer-readable tangible storage media for execution by at least one of the one or more processors via at least one of the one or more computer-readable memories, wherein the computer system is capable of performing a method comprising:
receiving a product return identifier associated with a product;
retrieving a plurality of product data based on the received product return identifier, wherein the retrieved plurality of product data includes one or more expected features;
generating one or more internal images of the product;
identifying one or more internal features of the product from the generated one or more internal images;
comparing the identified one or more internal features with the one or more expected features; and
in response to determining that the identified one or more internal features match the one or more expected features, accepting the product return.

9. The computer system of claim 8, further comprising:
retrieving an acceptance policy associated with the product based on the product return identifier, wherein the retrieved acceptance policy includes a plurality of acceptance terms;
determining whether the identified one or more internal features satisfies the plurality of acceptance terms; and
wherein accepting the product return further comprises determining that the identified one or more internal features satisfies the plurality of acceptance terms.

10. The computer system of claim 8, further comprising:
in response to determining that the identified one or more internal features do not match the one or more expected features, rejecting the product return.

11. The computer system of claim 9, further comprising:
determining that the one or more internal features are damaged; and
wherein the plurality of acceptance terms includes a damage deduction amount associated with a feature, and wherein accepting the product return further comprises deducting the damage deduction amount from a refund total based on determining that the one or more internal features are damaged and a corresponding damage deduction is present in the plurality of acceptance terms.

12. The computer system of claim 8, wherein the generating of the one or more internal images is performed by an internal imaging device located at a collection point where a customer brings the product for return.

13. The computer system of claim 8, wherein the one or more expected features comprises receiving one or more expected feature internal images.

14. The computer system of claim 13, wherein comparing the identified one or more internal features with the one or more expected features comprises using a supervised machine learning algorithm to compare internal feature images corresponding to the identified one or more internal features with the one or more expected feature internal images to determine if the internal feature images match any of the one or more expected feature internal images.

15. A computer program product for internal product composition analysis, comprising a computer-readable storage medium having program instructions embodied therewith, the program instructions executable by a processor to cause the processor to perform a method comprising:
receiving a product return identifier associated with a product;
retrieving a plurality of product data based on the received product return identifier, wherein the retrieved plurality of product data includes one or more expected features;
generating one or more internal images of the product;
identifying one or more internal features of the product from the generated one or more internal images;
comparing the identified one or more internal features with the one or more expected features; and
in response to determining that the identified one or more internal features match the one or more expected features, accepting the product return.

16. The computer program product of claim 15, further comprising:
retrieving an acceptance policy associated with the product based on the product return identifier, wherein the retrieved acceptance policy includes a plurality of acceptance terms;
determining whether the identified one or more internal features satisfies the plurality of acceptance terms; and
wherein accepting the product return further comprises determining that the identified one or more internal features satisfies the plurality of acceptance terms.

17. The computer program product of claim 15, further comprising:
in response to determining that the identified one or more internal features do not match the one or more expected features, rejecting the product return.

18. The computer program product of claim 16, further comprising:
determining that the one or more internal features are damaged; and
wherein the plurality of acceptance terms includes a damage deduction amount associated with a feature, and wherein accepting the product return further comprises deducting the damage deduction amount from a refund total based on determining that the one or more internal features are damaged and a corresponding damage deduction is present in the plurality of acceptance terms.

19. The computer program product of claim 15, wherein the generating of the one or more internal images is performed by an internal imaging device located at a collection point where a customer brings the product for return.

20. The computer program product of claim 15, wherein the one or more expected features comprises receiving one or more expected feature internal images.
